(19) United States
(12) Patent Application Publication
(10) Pub. No.: US 2008/0104500 A1
(43) Pub. Date: May 1, 2008

(54) METHOD AND SYSTEM FOR RECOVERING ONLINE FORMS

(76) Inventors: Glen Edmond Chalemin, Austin, TX (US); Alfredo V. Mendoza, Georgetown, TX (US); Clifford Jay Spinac, Austin, TX (US); Tiffany Lynn Winman, Phoenix, AZ (US)

Correspondence Address: IBM CORP (YA);C/O YEE & ASSOCIATES PC, P.O. BOX 802333, DALLAS, TX, 75380, US

(21) Appl. No.: 11/548,552

(22) Filed: Oct. 11, 2006

(51) Int. Cl. G06F 17/00; G06F 17/30

(52) U.S. Cl. 715/224; 715/221; 707/202; 707/204

(57) ABSTRACT

The illustrative embodiments provide a computer implemented method and system for recovering an incomplete, online form. A browser receives a document and determines whether the document is a first form. Responsive to the document being a first form, the browser initiates a handler to recognize a form exit event. Responsive to recognizing an occurrence of the form exit event, the browser saves the first form and data entered into the first form on a storage device to form at least one saved form. Responsive to opening the browser after the first form and the data entered into the first form have been saved, the browser retrieves the at least one saved form from the storage device. The browser populates the fields of a second form using the data from the at least one saved form. The second form is a blank copy of the at least one saved form.

### BACKGROUND OF THE INVENTION

1. Field of the Invention

The present invention relates generally to an improved data processing system and in particular to a method and system for managing online forms. Still more particularly, the present invention relates to a computer implemented method and a data processing system for recovering an incomplete, online form.

2. Description of the Related Art

Users frequently fill out forms online for a variety of purposes and reasons. Sometimes, the forms are short, but other times the forms are very long and request a lot of information. Occasionally, a browser that contains a form inadvertently exits because of a software bug, defect, or other failure. As a result, a user may lose all or a substantial portion of the information that was already input by the user. Consequently, the user has to start over and input all of the lost information again. The process is particularly cumbersome and frustrating when the form is long and requests a substantial amount of information.

Several solutions currently exist to allow a user to save a partially completed form. One solution allows a user to select a “save” button and save a copy of the partially completed form onto the server that manages the webpage from which the form originated. However, for security reasons, the session connection between the user and the web server is sometimes terminated after a period of time. Therefore, in order to save the form, the user needs to reestablish the connection, which, in the meantime, leaves the partially completed form unsaved and subject to the browser inadvertently exiting. As a result, a user may still have to start over and input the lost information into the form again if the browser exits prior to reestablishing the connection. Additionally, in order to implement the solution, an administrator needs to create and manage the “save” button feature. Due to overhead costs associated with creating and managing the save feature, many businesses opt to leave out the feature altogether.

Another solution exists that allows the application from which the form originated to automatically save the form on a periodic basis. However, like the previous solution discussed above, this solution requires an administrator to manage and identify the time period to save the data. Furthermore, the solution also requires additional storage space for saving the partially completed form. Many businesses do not include this type of feature due to cost constraints associated with managing and storing the partially completed forms.

### SUMMARY OF THE INVENTION

The illustrative embodiments provide a computer implemented method and system for recovering an incomplete, online form. A browser receives a document and determines whether the document is a first form. Responsive to a determination that the document is a first form, the browser initiates a handler to recognize a form exit event. Responsive to recognizing an occurrence of the form exit event, the browser saves the first form and data entered into the first form on a storage device. The first form and the data on the storage device forms at least one saved form. Responsive to opening the browser after the first form and the data entered into the first form have been saved, the browser retrieves the at least one saved form from the storage device. The browser then populates the fields of a second form using the data from the at least one saved form. The second form is a blank copy of the at least one saved form.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems, in which illustrative embodiments may be implemented;

FIG. 2 is a block diagram of a data processing system, in which illustrative embodiments may be implemented;

FIG. 3 is a block diagram of a browser program, in accordance with an illustrative embodiment;

FIG. 4 illustrates a data processing system with browsers and handlers, in accordance with an illustrative embodiment;

FIG. 5 is a flowchart illustrating the process for creating a handler, in accordance with an illustrative embodiment;

FIG. 6 is a flowchart depicting the process of saving a form subsequent to a form exit event, in accordance with an illustrative embodiment; and

FIG. 7 is a flowchart depicting the process of recovering a saved form, in accordance with an illustrative embodiment.

### DETAILED DESCRIPTION OF THE PREFERRED EMBODIMENT

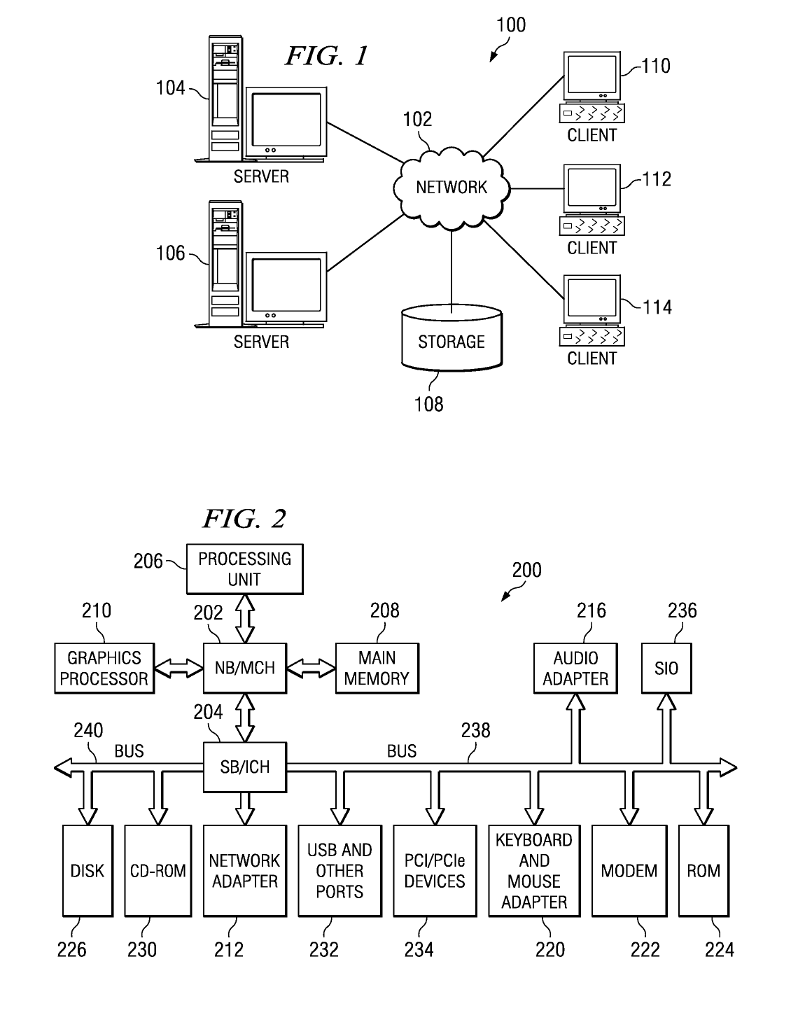

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

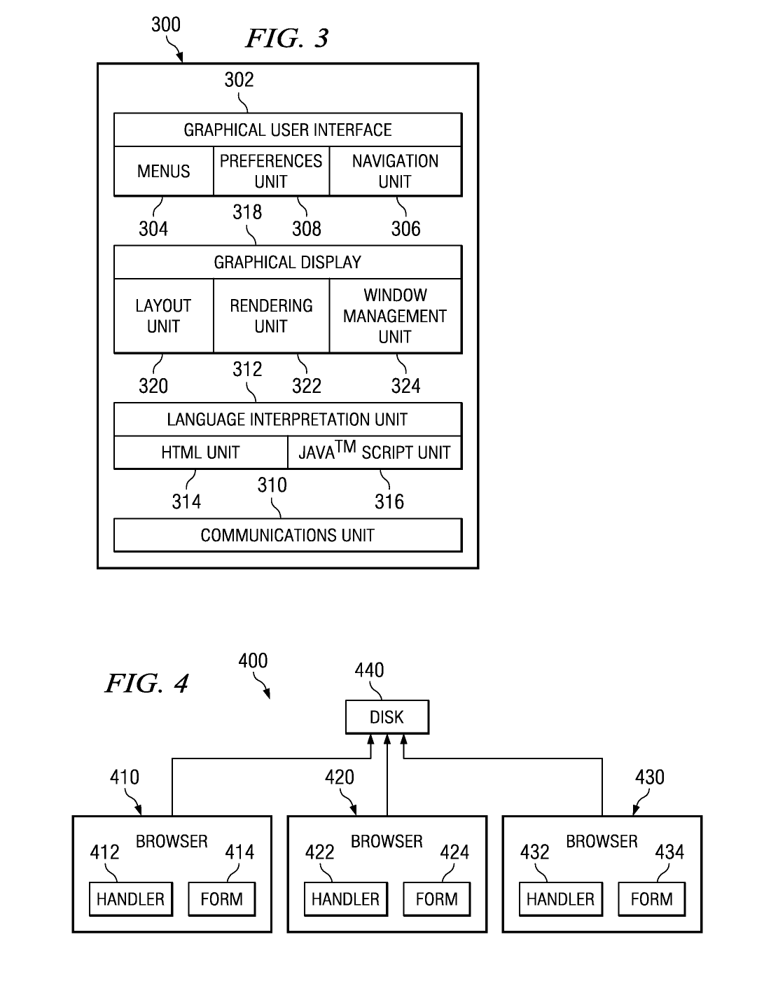

Turning next to FIG. 3, a block diagram of a browser program is depicted in accordance with an illustrative embodiment. A browser is an application used to navigate or view information or data in a distributed database, such as the Internet or the World Wide Web.

In this example, browser 300 includes a user interface 302, which is a graphical user interface (GUI) that allows the user to interface or communicate with browser 300. This interface provides for selection of various functions through menus 304 and allows for navigation through navigation unit 306. For example, menus 304 may allow a user to perform various functions, such as saving a file, opening a new window, displaying a history, and entering a Uniform Resource Locator (URL). Navigation unit 306 allows a user to navigate various web pages and to select web sites for viewing. For example, navigation unit 306 may allow a user to see a previous page or a subsequent page relative to the present page. Preferences such as those illustrated in FIG. 3 may be set through preferences unit 308.

Communications unit 310 is the mechanism with which browser 300 receives documents and other resources from a network such as the Internet. Further, communications unit 310 is used to send or upload documents and resources onto a network. In the depicted example, communications unit 310 uses Hyper Text Transfer Protocol (HTTP). Other protocols may be used depending on the implementation. Documents that are received by browser 300 are processed by language interpretation unit 312, which includes a Hyper Text Markup Language (HTML) unit 314 and a Java™Script unit 316. Language interpretation unit 312 will process a document for presentation on graphical display 318. In particular, HTML statements are processed by HTML unit 314 for presentation while Java™Script statements are processed by Java™Script unit 316.

Graphical display 318 includes layout unit 320, rendering unit 322, and window management unit 324. These units are involved in presenting web pages to a user based on results from language interpretation unit 312.

Browser 300 is presented as an example of a browser program in which an illustrative embodiment may be embodied. Browser 300 is not meant to imply architectural limitations to the present invention. Presently available browsers may include additional functions not shown, or may omit functions shown, in browser 300. A browser may be any application that is used to search for and display content on a distributed data processing system. Browser 300 may be implemented using known browser applications, such as Netscape Navigator® or Microsoft Internet Explorer®. Netscape and Netscape Navigator logos are registered trademarks of Netscape Communications Corporation in the United States and other countries. Microsoft, and the Microsoft Internet Explorer logo are trademarks, or registered trademarks, of Microsoft Corporation in the United States and/or other countries.

The illustrative embodiments provide a computer implemented method and system for recovering an incomplete, online form. A browser receives a document and determines whether the document as a first form. In response to a determination that the document is a first form, the browser initiates a handler to recognize a form exit event. A form exit event occurs when a user exits the browser, and the user subsequently confirms that the first form and the data entered into the first form are to be saved. A form exit event also occurs when the browser unexpectedly exits the first form.

In response to recognizing an occurrence of the form exit event, the browser saves the first form and data entered into the first form on a storage device. The first form and the data on the storage device forms at least one saved form. In response to opening the browser after the first form and the data entered into the first form have been saved, the browser retrieves the at least one saved form from the storage device. The browser then populates the fields of a second form using the data from the at least one saved form. The second form is a blank copy of the at least one saved form. In one embodiment, the at least one saved form includes an expiration tag. The browser will not retrieve the at least one saved form from storage device if the at least one saved form is expired.

FIG. 4 illustrates a data processing system with browsers and handlers, in accordance with an illustrative embodiment. Data processing system 400 is a networked computer, similar to client 110, 112, or 114 of FIG. 1 or data processing system 200 of FIG. 2. Data processing system 400 includes browser 410, browser 420, browser 430, and disk 440.

Browsers 410 through 430 are similar to browser 300 of FIG. 3 and allow a user of data processing system 400 to interact with a network, such as network 102 of FIG. 1. A processor unit, such as processing unit 206 of FIG. 2, executes browsers 410 through 430.

Browser 410 includes handler 412 and form 414. Handler 412 is an application feature within browser 410 that executes whenever a particular event or signal associated with a particular object occurs. For example, in the illustrative embodiment, handler 412 executes whenever browser 410 intentionally or unintentionally terminates while displaying form 414. Specifically, handler 412 executes a process to save form 414 into disk 440 whenever a user begins to fill out form 414 and browser 410 exits or closes for whatever reason.

Form 414 is an HTML document sent from a particular web site. Whenever a web page is opened in browser 410, browser 410 uses a parsing technique to read the tag on the HTML document that is opened. The tag identifies the type of document which was sent. If the document is identified as an HTML FORM, then browser 410 installs a callback or lower level executable code, such as handler 412, to execute whenever a user exits form 414. The callback is not installed if the HTML document does not include the “form” tag. In the illustrative embodiment, form 414 is identified with a “form” tag and browser 410 creates handler 412 with an instruction to execute whenever a user exits form 414.

Browser 400 displays form 414 so that a user can fill out form 414 using a graphical user interface. As a user begins filling out form 414, handler 412 is on stand by or hold until a form exit event triggers handler 412. Thus, handler 412 can trigger as early as when a user inputs one letter in form 414 or as late as when the entire form is filled out, but the user has not completed the last step, such as saving, printing, or sending form 414. Handler 412 executes upon the commencement of a form exit event. For example, a form exit event occurs when a user intentionally exits form 414 by closing browser 400, and the user confirms that form 414 should be saved in disk 440. In another embodiment, a form exit event occurs when browser 410 intentionally exits form 414 after the form 414 remains inactive or idle for a period of time. In yet another embodiment, a form exit event occurs when browser 410 unintentionally closes form 414 due to a software error, mistake, or failure in the application. In still yet another embodiment, a form exit event occurs when data processing system 400 informs the browser of the intent to shut down due to a request by the user or a power interruption. Handler 412 is inoperable or is turned “off” when browser 410 enters a different web page or browser 410 does not encounter a “form” tag on the newly displayed web page.

Handler 412 saves form 414 into a saved area of disk 440 for later retrieval when a form exit event occurs. In the illustrative embodiment, disk 440 is a storage device that is similar to hard drive disk 226 of FIG. 2. In another embodiment, disk 440 may be any storage device, including but not limited to a flash memory.

The saved area for disk 440 is a file in disk 440. Anytime a user opens browser 410, browser 410 checks the saved area for any saved form files. If at least one file for a saved form exists in the saved area of disk 440, then browser 410 locates the original URL for the saved form. Browser 410 then retrieves a blank copy, or a copy that does not have any data entered by a user into the fields, of the saved form. Browser 410 populates the fields of the blank copy with the saved data from the saved form. Browser 410 then displays the filled-in copy of the saved form to the user on a graphical user interface.

Each instance of browser 410 only displays one saved form at a time. An instance is a single occurrence of a particular event. Thus, in the illustrative embodiment, an instance is each time a user opens browser 410. Therefore, in the illustrative embodiment, a single instance of browser 410 only displays form 414 and no other saved forms.

Browser 410 may not retrieve form 414 from disk 440 if form 414 is saved with an expiry tag. An expiry tag is a date and/or time at which form 414 is no longer available for use by a user. An expiry tag can be used to prevent a user from completing a form that has been updated or revised. An expiry tag is saved along with the information filled out by a user for form 414.

An expiry tag is time-based and set to expire after a certain period of time has elapsed, such as 24 or 48 hours. A user can create an expiry tag using the user preference settings in browser 410. The expiry tag can also be a default setting within browser 410 or established by the webpage from which form 414 originated. In the illustrative embodiment, if both the user and the webpage from which form 414 originated create an expiry tag, the expiry tag established by the webpage will take precedence over the expiry tag established by the user.

Browsers 420 and 430 are similar to browser 410. Browser 420 includes handler 422 and form 424, while browser 430 includes handler 432 and form 434. In the illustrative embodiment, browsers 420 and 430 interact with websites that include a form for the user to complete. In the illustrative embodiment, browsers 410, 420, and 430 do not interact with the same website and forms 414, 424, and 434 are completely different forms.

In the illustrative embodiment, whenever a user opens a browser, such as browser 410, 420, or 430, and a document with a “form” tag, such as form 414, 424, or 434, is received by the browser, the browser creates a separate handler for each instance of each form. Thus, in the illustrative embodiment, browser 410 creates handler 412 for form 414; browser 420 creates handler 422 for form 424; and browser 430 creates handler 432 for form 434. Each instance of a browser only includes one handler. Therefore, in the illustrative embodiment, in order for browser 410 to create handler 412, any old handler saved in browser 410 is deleted prior to browser 410 creating handler 412. The old handler is deleted by deleting or removing the file for the old handler from the saved area of disk 440. Likewise, any old handler saved in browsers 420 and 430 are also deleted prior to creating handlers 422 and 432, respectively.

Each browser 410 through 430 connects to disk 440. Whenever a form exit event occurs for each browser 410 through 430, handler 412 through 432 saves form 414 through 434, respectively, into disk 440. A separate file for each form is created in disk 440. Therefore, when displayed on a graphical user interface, disk 440 displays a directory of files, with each file representing one form.

Whenever a user next opens a new browser, any form, form 414, 424, or 434, saved in disk 440 is retrieved. Only one form is displayed per instance of each browser. Thus, forms 414, 424, and 434 will be displayed for the next three new browsers opened by the user. The illustrative embodiments are not limited to any particular order of saving into disk 440 or order of retrieval from disk 440. The illustrative embodiments are also not limited to the type of form that is saved.

When a user intentionally exits browser 410, 420, or 430, browser 410, 420, or 430 displays a dialogue box or a graphical user interface to confirm whether the user wishes to save form 414, 424, or 434, respectively, prior to exiting browser 410, 420, or 430. In one embodiment, each browser 410, 420, and 430 can display a separate dialogue box specific to each browser 410, 420, and 430. In an alternative embodiment, one dialogue box can be displayed to save or not save all forms 414 through 434 for all browsers 410 through 430. In yet another embodiment, a dialogue box for each browser 410, 420, and 430 can provide an option to save or not save only form 414, 424, or 434, respectively, or all forms 414 through 434.

In use, a user requests browser 410, 420, or 430 to open a webpage that contains form 414, 424, or 434, respectively. Browser 410, 420 or 430 reads the “form” tag for the opened webpage and creates handler 412, 422, or 432, respectively. Browser 410, 420, or 430 then recognizes a form exit event. If the form exit event occurs because the user intentionally exits browser 410, 420, or 430, then the browser from which the user is exiting displays a dialogue box confirming whether the current form in the exiting browser should be saved. In another embodiment, the exiting browser can also include a confirmation on whether all forms in the other browsers should also be saved. If the user decides to save the current form or all the forms, handler 412, 422, or 432 sends form 414, 424, or 434 to disk 440 to be saved. If the form exit event occurs for another reason, handler 412, 422, or 432 automatically sends form 414, 424, or 434, respectively, to be saved in disk 440.

When the user next opens another instance of a browser, the browser checks disk 440 to determine whether disk 440 has any saved forms. Once the browser recognizes form 414, 424, or 434, the browser determines whether form 414, 424, or 434 has an expiry tag. If an expiry tag exists, then the browser determines whether form 414, 424, or 434 has expired by comparing the date and time recorded in the expiry tag against the date and time of data processing system 400. If the date and time recorded in the expiry tag in form 414, 424, or 434 is prior to the date and time of data processing system 400, then respective form 414, 424, or 434 is expired. If form 414, 424, or 434 has expired, the browser removes form 414, 424, or 434 from disk 440.

If form 414, 424, or 434 is not expired or no expiry tag exists for form 414, 424, or 434, then the browser retrieves form 414, 424, or 434 from the saved area in disk 440. The browser then returns the user to the original URL from which form 414, 424, or 434 originated and retrieves a blank copy of form 414, 424, or 434. The browser then populates the corresponding fields for form 414, 424, or 434 by matching the field tags in form 414, 424, or 434. Each field in form 414, 424, and 434 includes a field tag that identifies the particular field. For example, in the illustrative embodiment, a “user name” field in form 414 will have a tag that identifies the field as “user name.” When a form exit event occurs, both the information filled in by the user as well as the tag for the fields are saved. When the browser retrieves form 414 from the saved area in disk 440, the browser matches the field tags from form 414 against the field tags from the blank form 414. Thus, for example, in the illustrative embodiment, browser 414 matches the “user name” field tags and then populates the information entered by the user into the “user name” field.

The illustrative embodiments are not limited to the depicted example. For example, the illustrative embodiments may also include more or fewer browsers. Additionally, a person of ordinary skill may also use other techniques for identifying HTML document types without deviating from the scope of the illustrative embodiments.

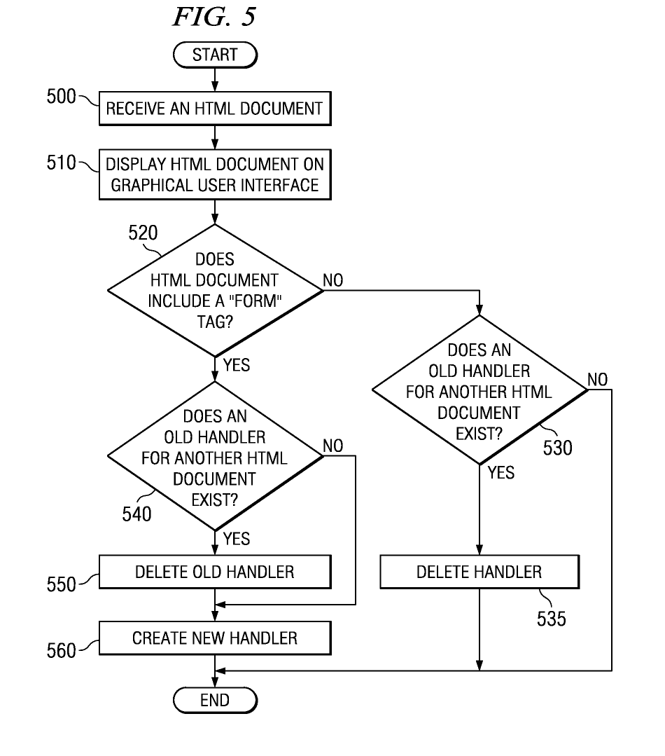

FIG. 5 is a flowchart illustrating the process for creating a handler, in accordance with an illustrative embodiment. The following process is exemplary only and the order of each step may be interchanged without deviating from the scope of the invention. The process is executed in a browser, such as browser 300 of FIG. 3 or browser 410, 420, or 430 of FIG. 4.

The process begins with a user receiving an HTML document that the user requested from a web site (step 500). The browser displays the HTML document on a graphical user interface for use by the user (step 510). The browser then reads the tags on the HTML document and determines whether the HTML document includes a “form” tag (step 520). If the HTML document does not contain a “form” tag (“no” output to step 520), the browser determines whether an old handler for another HTML document exists (step 530). If an old handler does not exist (“no” output to step 530), then the process terminates. Returning to step 530, if an old handler does exist (“yes” output to step 530), then the old handler is deleted (step 535), with the process terminating thereafter.

Returning to step 520, if the HTML document includes a “form” tag (“yes” output to step 520), the browser determines whether an old handler for another HTML document exists (step 540). If an old handler exists (“yes” output to step 540), the old handler is deleted (step 550). The browser then creates a new handler (step 560), with the process terminating thereafter. Returning to step 540, if an old handler does not exist (“no” output to step 540), then a new handler is created (step 560), with the process terminating thereafter.

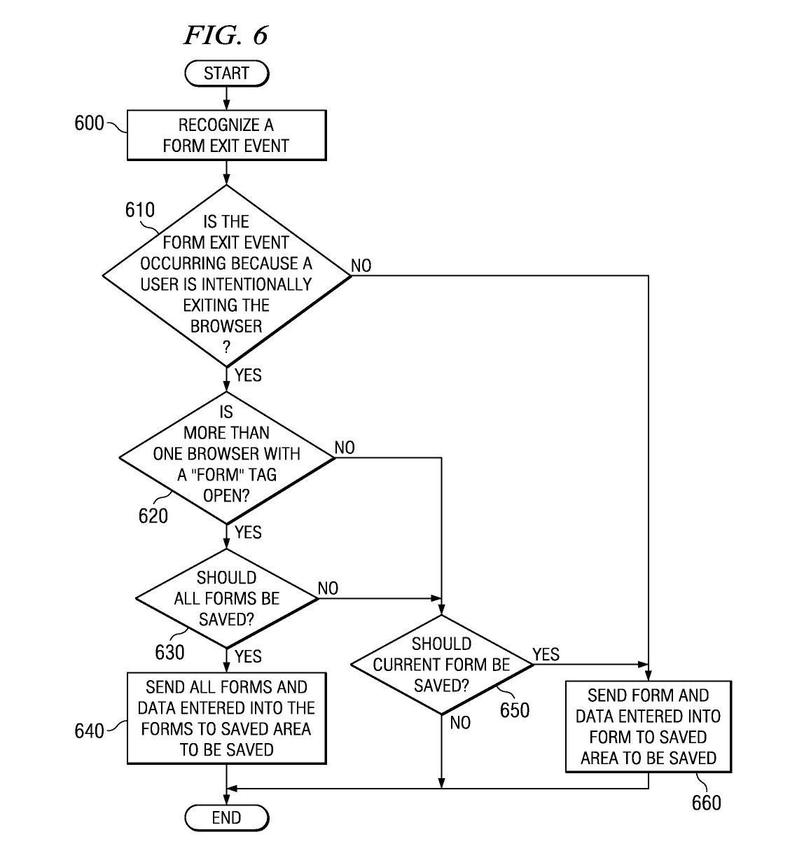

FIG. 6 is a flowchart depicting the process of saving a form subsequent to a form exit event, in accordance with an illustrative embodiment. The following process is exemplary only and the order of each step may be interchanged without deviating from the scope of the invention. The process is executed in a handler, such as handler 412, 422, or 432 of FIG. 4.

The process begins with the handler recognizing a form exit event (step 600). The handler then determines whether the form exit event is occurring because a user is intentionally exiting the browser (step 610). If the user is intentionally exiting the browser (“yes” output to step 610), then the handler determines whether more than one browser with a “form” tag is open (step 620). If more than one browser with a “form” tag is open (“yes” output to step 620), then the handler transmits a message to the user asking whether all the forms in all the browsers should be saved (step 630). If the user confirms that all forms should be saved (“yes” output to step 630), then the handler sends all the forms along with any data entered into the forms from all the browsers to the saved area in the disk (step 640), with the process terminating thereafter.

Returning to step 630, if the user indicates that not all forms should be saved (“no” output to step 630), the handler then transmits a message to the user to determine whether the current form should be saved (step 650). If the user indicates that the current form should be saved (“yes” output to step 650), then the handler sends the current form along with any data entered into the current form to the saved area of a disk to be saved (step 660), with the process terminating thereafter. Returning to step 650, if the user indicates that the current form should not be saved (“no” output to step 650), the process terminates.

Returning to step 620, if the handler determines that only one browser with a “form” tag is open (“no” output to step 620), the handler then transmits a message to the user to determine whether the current form should be saved (step 650). If the user indicates that the current form should be saved (“yes” output to step 650), then the handler sends the current form along with any data entered into the current form to the saved area of a disk to be saved (step 660), with the process terminating thereafter. Returning to step 650, if the user indicates that the current form should not be saved (“no” output to step 650), the process terminates.

Returning to step 610, if the form exit event is occurring for another reason (“no” output to step 610), then the handler sends the form along with any data entered into the form to the saved area of a disk to be saved without querying the user (step 660). The process terminates thereafter.

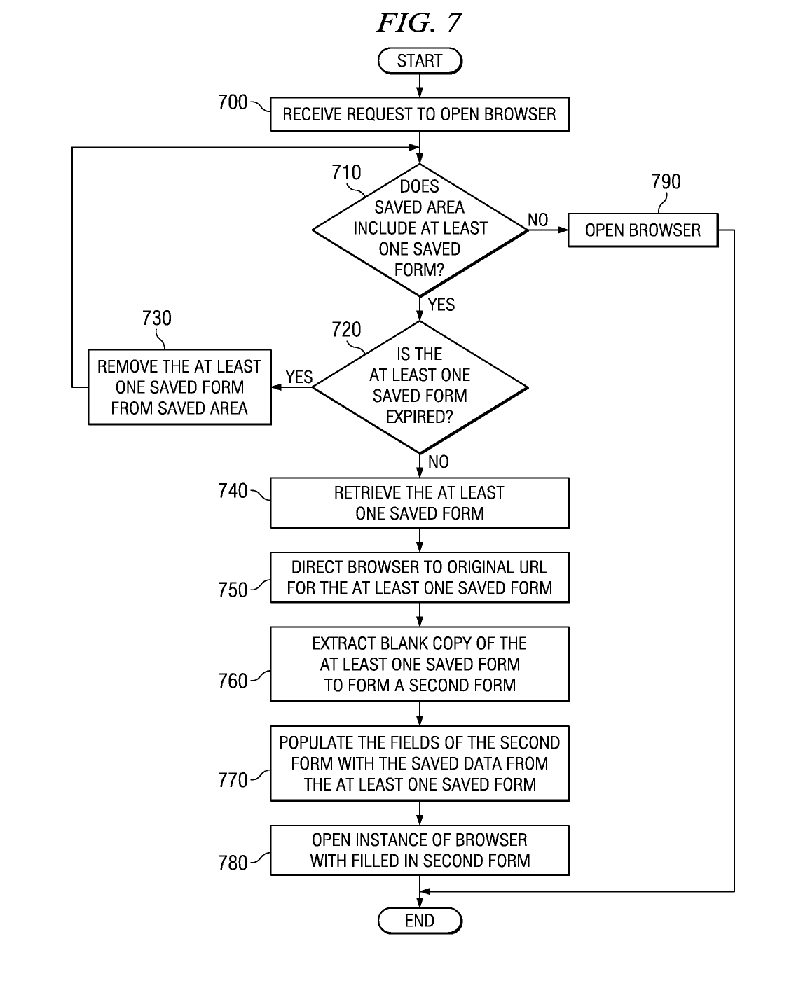

FIG. 7 is a flowchart depicting the process of recovering a saved form, in accordance with an illustrative embodiment. The following process is exemplary only and the order of each step may be interchanged without deviating from the scope of the invention. The process is executed in a data processing system, such as data processing system 400 of FIG. 4, and a browser, such as browser 300 of FIG. 3 or browser 410, 420, or 430 of FIG. 4.

The process begins with the data processing system receiving a request to open a browser (step 700). After the browser is opened, the browser determines whether a saved area in a disk includes at least one saved form (step 710). If the saved area in the disk includes at least one saved form (“yes” output to step 710), the browser determines whether the at least one saved form is expired (step 720). If the at least one saved form is expired (“yes” output to step 720), then the browser removes or deletes the file for the at least one saved form from the saved area in the disk (step 730), with the process returning to step 710 to repeat.

Returning to step 720, if the at least one saved form is not expired (“no” output to step 730), then the browser retrieves the at least one saved form (step 740). The data processing system then directs the browser to the original URL for the at least one saved form (step 750). The browser then extracts a blank copy of the at least one saved form from the original URL (step 760). The blank copy forms a second form. The browser then populates the fields of the second form with the saved data from the at least one saved form (step 770). The data processing system then opens another instance of the browser with the filled in second form (step 780), with the process terminating thereafter.

Returning to step 710, if the browser determines that at least one saved form does not exist in the saved area of the disk (“no” output to step 710), the data processing system opens the browser (step 790). The process terminates thereafter.

The illustrative embodiments provide a computer implemented method and system for recovering an incomplete, online form. A browser receives a document and determines whether the document as a first form. In response to a determination that the document is a first form, the browser initiates a handler to recognize a form exit event. A form exit event occurs when a user exits the browser, and the user subsequently confirms that the first form and the data entered into the first form are to be saved. A form exit event also occurs when the browser unexpectedly exits the first form.

In response to recognizing an occurrence of the form exit event, the browser saves the first form and data entered into the first form on a storage device. The first form and the data on the storage device forms at least one saved form. In response to opening the browser after the first form and the data entered into the first form have been saved, the browser retrieves the at least one saved form from the storage device. The browser then populates the fields of a second form using the data from the at least one saved form. The second form is a blank copy of the at least one saved form. In one embodiment, the at least one saved form includes an expiration tag. The browser will not retrieve the at least one saved form from storage device if the at least one saved form is expired.

The illustrative embodiments allow a user to save a partially completed form. Since the partially completed forms are saved in the local hard drive disk of the data processing system for a user, an administrator for the webpage does not need to create and manage any save features. Additionally, the business hosting the webpage does not incur any additional costs associated with storing and managing the partially completed forms or the save feature associated with saving the forms. Moreover, if a form exit event does occur, the illustrative embodiment reduces any frustrations associated with the form completion process, because a user does not have to start over and input information into the entire form again.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for recovering an incomplete, online form, the computer implemented method comprising:
receiving a document in a browser;
determining whether the document is a first form;
responsive to a determination that the document is a first form, initiating a handler to recognize a form exit event;
responsive to recognizing an occurrence of the form exit event, saving the first form and data entered into the first form on a storage device, wherein the first form and the data on the storage device forms at least one saved form;
responsive to opening the browser after the first form and the data entered into the first form have been saved, retrieving the at least one saved form from the storage device; and
populating fields of a second form using the data from the at least one saved form, wherein the second form is a blank copy of the at least one saved form.

2. The computer implemented method of claim 1, wherein the form exit event comprises a user exiting the browser, and wherein the user confirms that the first form and the data entered into the first form are to be saved.

3. The computer implemented method of claim 1, wherein the form exit event comprises the browser unexpectedly exiting the first form.

4. The computer implemented method of claim 1, wherein the browser does not retrieve the at least one saved form from the disk if the at least one saved form is expired.

5. The computer implemented method of claim 1, wherein the storage device is a disk.

6. A data processing system comprising:
a browser that receives a document, wherein the browser determines whether the document is a first form;
a handler coupled to the browser, wherein the browser initiates the handler in response to determining that the document is a first form, and wherein the handler recognizes a form exit event;
a storage device accessible by the browser, wherein the storage device saves the first form and data entered into the first form in response to the occurrence of the form exit event, and wherein the first form and the data on the storage device forms at least one saved form, and wherein the browser retrieves the at least one saved form from the storage device in response to a user opening the browser after the first form and the data entered into the first form have been saved; and
a second form displayed by the browser, wherein the browser populates fields of the second form using the data from the at least one saved form, and wherein the second form is a blank copy of the at least one saved form.

7. The data processing system of claim 6, wherein the form exit event comprises the user exiting the browser, and wherein the user confirms that the first form and the data entered into the first form are to be saved.

8. The data processing system of claim 6, wherein the form exit event comprises the browser unexpectedly exiting the first form.

9. The data processing system of claim 6, wherein the at least one saved form comprises an expiration tag, and wherein the browser does not retrieve the at least one saved form from the disk if the form is expired.

10. The data processing system of claim 6, wherein the storage device is a disk.
